(19) United States
(12) Patent Application Publication
(10) Pub. No.: US 2013/0325710 A1
(43) Pub. Date: Dec. 5, 2013

(54) SYSTEM AND METHOD FOR RULE-BASED PRESENTMENT AND PAYMENT OF BILLS OR INVOICES

(71) Applicants: Deepak Hoshing, Bangalore (IN); Arunnima Balakrishnan Senakumari, Thiruvananthapuram (IN); Dinesh Chennabasavan Thogarapalli, Bangalore (IN); Rivi Varghese, Bangalore (IN)

(72) Inventors: Deepak Hoshing, Bangalore (IN); Arunnima Balakrishnan Senakumari, Thiruvananthapuram (IN); Dinesh Chennabasavan Thogarapalli, Bangalore (IN); Rivi Varghese, Bangalore (IN)

(21) Appl. No.: 14/000,109

(22) PCT Filed: Mar. 21, 2011
(86) PCT No.: PCT/IN11/00184

§ 371 Date: Aug. 16, 2013

(51) Int. Cl. G06Q 20/10

(52) U.S. Cl. CPC G06Q 20/102
USPC 705/40

(57) ABSTRACT

A computer-implemented method for facilitating presentment and payment of bills or invoices related to consumption of products and services between a biller and a payer via an online payment portal over a communication network is provided. A template is generated that defines terms and conditions related to payment of a bill or invoice. The terms and conditions are accepted by the payer and the payer's financial institution and received from the biller. One or more rules are derived from data related to the terms and conditions defined in the template. The derived one or more rules are applied on the bill or invoice associated with the template to derive processing logic. Payment of the bill or invoice made by the payer is processed using the derived processing logic.

### FIELD OF THE INVENTION

The present invention relates generally to the field of electronic payment and presentment of bills or invoices and more particularly to a system and method for facilitating payment of bills or invoices employing rules derived from terms and conditions agreed between biller and payer and between biller and payer's financial institution.

### BACKGROUND OF THE INVENTION

With the advent of electronic commerce, several products and services are made available to users for online purchase by various companies. Such companies (referred as billers) facilitate the users (referred as payers) to receive bills or invoices and pay for the bills or invoices via secure online portals operated by the payer's financial institution (e.g. banks). Such secure online portals therefore facilitate presentment and payment of bills or invoices. However, payment of bills or invoices by the payer's financial institution is limited to debiting billed amount from payer's account and crediting biller's account. The financial institutions therefore act as intermediaries for receiving payments and transferring payments to the billers.

Conventionally, bill presentment and payment systems do not address variabilities required to cater to a wide variety of billers and payers during presentment and payment of bills or invoices with electronically stated and processed terms and conditions for payment. In particular, this is true for billers who are individual or small to medium enterprise (SME) billers. Variabilities may include several rules which may be based on terms and conditions agreed between biller and payer. Existing systems do not facilitate implementing and processing such rules before presenting bills or invoices to payers and accepting payments made by payers. Such rules may relate to early payment discount, calculation of late payment charges, acceptance of partial payments etc. Further, existing systems do not facilitate implementation of rules which are required for calculation of commission which is due to payer's financial institution, particularly if the biller is an individual or SME.

In light of the above, there is a need for a system and method that facilitates implementing terms and conditions of the biller for processing payments made by the payer. Also, there is a need for a system and method which is employed by the payer's financial institution for processing payments made by payer based on terms and conditions agreed between biller and payer's financial institution. Further, there is a need for a system and method for translating terms and conditions of the biller into rules before processing payments made by the payer. Also, there is a need for a system and method for automated calculation of fee or commission which is due to payer's financial institution based on the rules as agreed between biller and payer's institution.

### SUMMARY OF THE INVENTION

A computer-implemented method for facilitating presentment and payment of bills or invoices related to consumption of products and services between a biller and a payer via an online payment portal over a communication network is provided. The method comprises generating a template, by program instructions executed by a computer system, defining terms and conditions related to payment of a bill or invoice. The terms and conditions are accepted by the payer and the payer's financial institution and received from the biller. The method further comprises deriving one or more rules, by program instructions executed by a computer system, from data related to the terms and conditions defined in the template. Further, the method comprises applying the derived one or more rules, by program instructions executed by a computer system, on the bill or invoice associated with the template to derive processing logic. Furthermore, the method comprises processing payment of the bill or invoice made by the payer, by program instructions executed by a computer system, using the derived processing logic.

In an embodiment of the present invention, the terms and conditions between the biller and the payer comprises at least one of: percentage values for calculation of late payment fees, percentage values for early payment discounts, percentage values for partial payments, allowing for excessive payments, allowing payment of bills or invoices in an order other than bill or invoice date, differential pricing based on payer categorization made by payer's financial institution, and usage of a predetermined algorithm running as web services on external websites for calculation of late payment fees, early payment discounts, minimum payment amounts and reward points. In another embodiment of the present invention, the terms and conditions between the biller and payer's financial institution comprises at least one of: percentage values for calculation of commission related to the payer's financial institution for facilitating collection of bill or invoice and usage of a predetermined algorithm running as web services on external websites for calculation of commission amount.

In various embodiments of the present invention, a computer-implemented method for facilitating presentment and payment of bills or invoices related to consumption of products and services between a biller and a payer via an online payment portal over a communication network is provided. The method comprises generating a template, by program instructions executed by a computer system, defining terms and conditions received from the biller and accepted by the payer and the payer's financial institution. The template is allotted a unique template identification that corresponds to the biller and one or more payers. The method further comprises presenting, by program instructions executed by a computer system, a bill or invoice based on data received from the biller, via a user interface. The bill or invoice indicates at least the unique template identification. Furthermore, the method comprises identifying, by program instructions executed by a computer system, the template based on at least the unique template identification indicated in the bill or invoice after the bill or invoice is accessed by the payer, via a user interface, for payment. The method further comprises deriving one or more rules, by program instructions executed by a computer system, from data related to the terms and conditions defined in the identified template and applying the derived one or more rules, by program instructions executed by a computer system, on the bill or invoice associated with the identified template to derive processing logic. The method finally comprises processing payment of the bill or invoice, by program instructions executed by a computer system, by applying the derived processing logic.

In an embodiment of the present invention, deriving one or more rules from the terms and conditions defined in the template comprises deriving rules that result in variation in the payment amount in relation to the amount indicated in the bill or invoice. In another embodiment of the present invention, processing payment of the bill or invoice by applying the derived processing logic further comprises calculating a fee or a discount, by program instructions executed by a computer system, different from the amount indicated in the bill or invoice based on the one or more derived rules.

In another embodiment of the present invention, processing payment of the bill or invoice by applying the derived processing logic further comprises comparing payment details, by program instructions executed by a computer system, received from the payer, via a user interface, with payment details indicated in the bill or invoice. The method further comprises validating the payment details, by program instructions executed by a computer system, against the one or more derived rules. The one or more derived rules comprises at least one of: late payment, early payment, minimum amount, partial payment, differential pricing, excess payment, and paying bill or invoices or invoices in an order other than first in first out. Finally, the method comprises calculating a fee or discount, by program instructions executed by a computer system, based on the validation.

In an embodiment of the present invention, the payment details comprises at least one of: date of payment and amount of payment. In another embodiment of the present invention, the bill or invoice further indicates a bill identification, bill due date and payment amount.

In an embodiment of the present invention, processing payment of the bill or invoice by applying the derived processing logic further comprises assessing reward points, by program instructions executed by a computer system, to be provided to the payer based on the derived rules.

In an embodiment of the present invention, processing payment of the bill or invoice by applying the derived processing logic further comprises at least one of: restricting payments from pre-determined payment modes which includes restricting payments from pre-determined account types, and restricting payments from predetermined channels from which payment is not permitted.

In various embodiments of the present invention, a system for facilitating presentment and payment of bills or invoices related to consumption of products and services between at least one biller and at least one payer via an online payment portal over a communication network is provided. The system comprises a template module on a computer system and configured to generate at least one template defining terms and conditions. The at least one template is allotted a unique template identification that corresponds to the at least one biller and at least one payer. The system further comprises a rules engine on the computer system and in communication with the template module. The rules engine is configured to identify the at least one template corresponding to the at least one biller and the at least one payer using the unique template identification, after the bills or invoices are accessed by the at least one payer. The rules engine is further configured to derive one or more rules based on data related to the terms and conditions defined in the identified template and process payment of the bills or invoices by applying the one or more derived rules.

In an embodiment of the present invention, the system further comprises a biller user interface on the computer system and configured to receive data related to terms and conditions between payer and corresponding biller and further configured to receive data related to bills or invoices for presentment of the bills or invoices. In another embodiment of the present invention, the system further comprises a payer user interface on the computer system and configured to receive data related to payment of bills or invoices.

In an embodiment of the present invention, the system further comprises a payment calculation module on the computer system and in communication with the rules engine. The payment calculation module is configured to calculate a fee or discount different from the amount indicated in the bill based on one or more percentage values determined by the derived rules.

In another embodiment of the present invention, the system further comprises a payment calculation module on the computer system and in communication with the rules engine. The payment calculation module is configured to invoke a web service on an external website for calculation of fee or discount different from the amount indicated in the bill or invoice using a predetermined algorithm and for calculation of commission which is due to payer's financial institution for facilitation of bill or invoice collection service.

In yet another embodiment of the present invention, the system further comprises a rewards module on the computer system and in communication with the rules engine. The rewards module is configured to at least one of: assess reward points for allotting to the payer based on the rules derived from the terms and conditions and calculate a discounted amount on the bill or invoice by deducting a reward amount from the bill or invoiced amount.

### BRIEF DESCRIPTION OF THE ACCOMPANYING DRAWINGS

The present invention is described by way of embodiments illustrated in the accompanying drawings wherein:

FIG. 1 is a block diagram of a system in which various embodiments of the present invention are embodied for facilitating rule-based presentment and payment of bills or invoices;

FIG. 2 illustrates a system environment in a payer's financial institution via which the bill presentment and payment module operates for facilitating rule-based presentment and payment of bills or invoices, in accordance with an embodiment of the present invention;

FIG. 3 is a detailed block diagram of the bill presentment and payment module, in accordance with an embodiment of the present invention;

FIG. 4 illustrates a flowchart of a method for rule-based presentment and payment of bills or invoices, in accordance with an embodiment of the present invention; and

FIGS. 5A and 5B is an exemplary XML code illustrating the method of the present invention in accordance with various embodiments of the present invention.

### DETAILED DESCRIPTION OF THE INVENTION

A system and method is provided that facilitates a bill presentment and payment module to translate terms and conditions agreed upon between the biller and payer and between biller and payer's financial institution into one or more rules. The one or more rules are used for processing payment of bills or invoices by the payer. The invention also facilitates automatically calculating additional fees or discounts which are different from billed amount based on one or more rules. The invention further facilitates performing rewards or incentives analysis based on one or more rules. The invention also facilitates calculation of commission payable to payer's bank by the biller.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purpose of clarity, details relating to technical material that is known in the technical fields related to the invention have been briefly described or omitted so as not to unnecessarily obscure the present invention.

The present invention would now be discussed in context of embodiments as illustrated in the accompanying drawings.

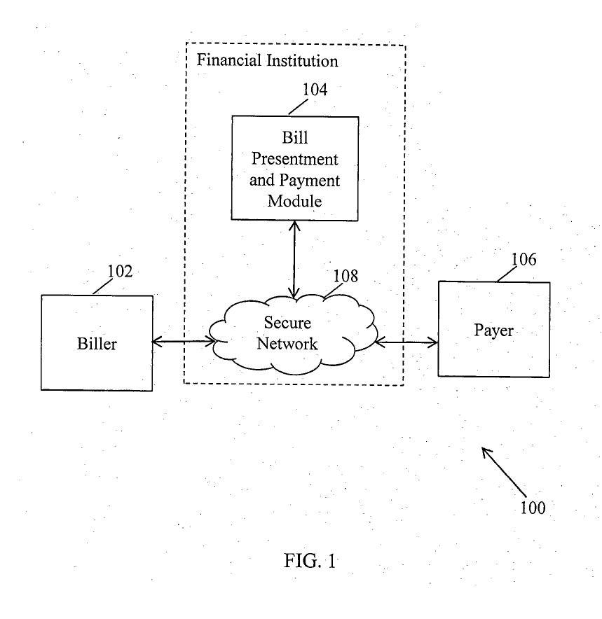

FIG. 1 is a block diagram of a system 100 in which various embodiments of the present invention are embodied for facilitating rule-based presentment and payment of bills or invoices. In various embodiments of the present invention, the system 100 comprises a biller 102, a bill presentment and payment module 104, and a payer 106. The biller 102 and payer 106 communicate with the bill presentment and payment module 104 in the financial institution over a secure network 108.

Biller 102 may be an individual, a small and medium enterprise, or a large enterprise which facilitates a payer 106 to consume products and/or services offered by the biller 102 and also make online payments for the products/services consumed. In an embodiment of the present invention, the system 100 facilitates the biller 102 to present bills or invoices for products or services consumed by the payer 106 via a bill presentment and payment module 104. In another embodiment of the present invention, the system 100 facilitates the payer 106 to make payments online via the bill presentment and payment module 104. In another embodiment of the present invention, the system 100 facilitates to send alerts to the biller 102 and payer 106 related to, but not limited to, bill generation, bill payment due date, payment confirmation etc.

In an embodiment of the present invention, the bill presentment and payment module 104 is a software module residing in an online payment portal of the financial institution which facilitates receiving a set of terms and conditions that have been agreed upon between the biller and the payer for facilitating payment of bills or invoices. In another embodiment of the present invention, the bill presentment and payment module 104 facilitates receiving a set of terms and conditions agreed between biller and payer's financial institution for processing the payments received from the payer.

In another embodiment of the present invention, the bill presentment and payment module 104 facilitates the biller 102 to upload bills or invoices for presenting the bills or invoices to the payer 106 and processing payment which is made by the payer 106. In an embodiment of the present invention, the bill presentment and payment module 104 facilitates translating predetermined terms and conditions set by the biller 102 into rules for processing payment of the bills or invoices made by the payer 106. In an embodiment of the present invention, based on the rules, a late payment fee or a discount may be calculated which differs from the payment amount indicated in the bill or invoice based on predetermined terms and conditions set by the biller 102. In another embodiment of the present invention, based on predetermined rules, rewards may be provided to payers 106 for including, but not limited to, early payments, making online payments etc.

In yet another embodiment of the present invention, the bill presentment and payment module 104 may facilitate altering one or more details related to the bill or invoice. In case, the biller 102 is a small to medium enterprise that does not have a facility to automatically generate bills or invoices, the bills or invoices can be created manually using a user interface provided to biller 102 in the bill presentment and payment module 104. The user interface facilitates entry of details such as payer details, services consumed, billed period, bill amount, bill date, payment due date, minimum payment amount etc. In case, the biller 102 is a large enterprise, the biller 102 has the facility to generate a single file from the Enterprise Resource Planning (ERP) system that contains details of the bills or invoices to be presented to the payer 106. The bills or invoices can then be uploaded into the bill presentment and payment module 104, for the payer to view the bills or invoices and make payments. In case of a disagreement and negotiation between biller 102 and payer 106 on the billed amount or details or due date, the user interface provided by bill payment and presentment module 104 facilitates the biller 102 to withdraw previously presented bill or invoice and resubmit a new bill or invoice.

In an embodiment of the present invention, the bill presentment and payment module 104 may be operable via an online payment portal of the payer's 106 financial institution. In an exemplary embodiment of the present invention, the online payment portal may include a secure portal which may be an extension of internet banking portal of the payer's 106 bank. In an embodiment of the present invention, the biller 102 and payer 106 accesses the bill presentment and payment module 104 via the online payment portal. The online payment portal may in turn be accessed via multiple channels over the secure network 108 using one or more electronic communication devices. In an exemplary embodiment of the present invention, the electronic communication devices may include, but is not limited to, personal computer, laptop, personal digital assistant, mobile handset or any other fixed or portable communication device. The multiple channels through which the payer 106 can access the online payment portal may include, but is not limited to, Internet, Interactive Voice Response (IVR), Automatic Teller Machine (ATM), Kiosks etc. The secure network 108 may include a high speed communication network which facilitates the biller 102 and payer 106 to securely access information stored in the bill presentment and payment module 104. All transactions conducted via the secure network 108 may be performed by employing various encryption technologies including, but not limited to, Secure Sockets Layer (SSL), Hypertext Transfer Protocol Secure (HTTPS) etc.

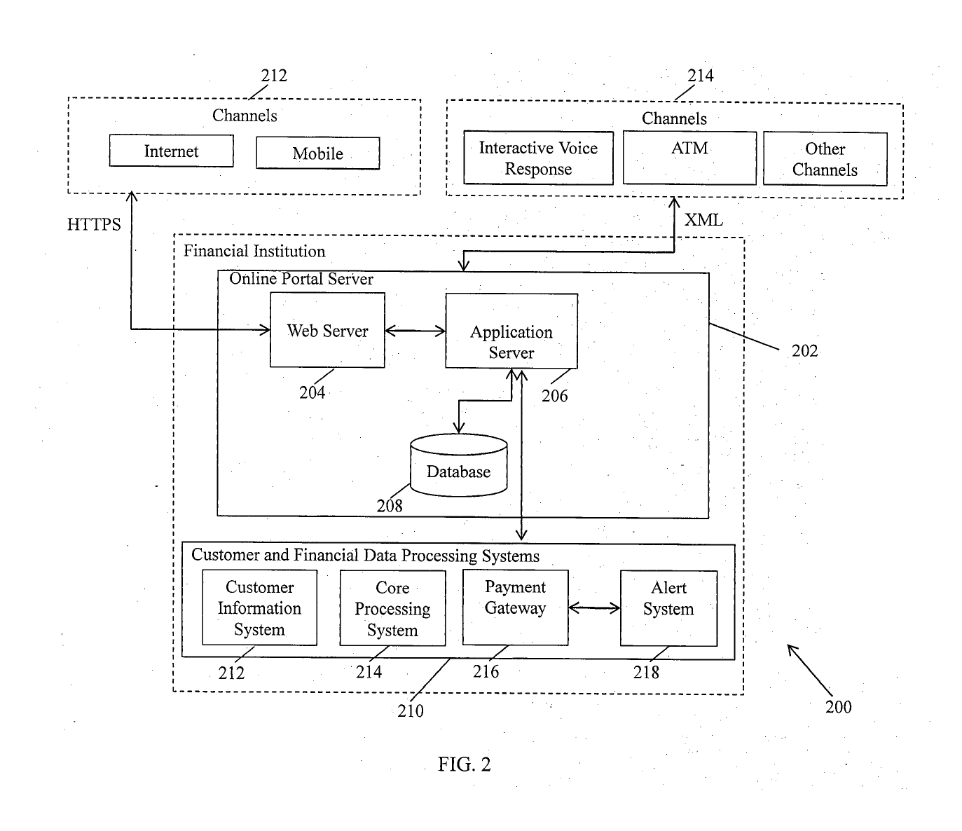

FIG. 2 illustrates a system environment in the payer's financial institution via which the bill presentment and payment module operates for facilitating rule-based presentment and payment of bills or invoices, in accordance with an embodiment of the present invention.

In operation, requests made by the biller 102 (FIG. 1) and the payer 106 (FIG. 1) to access information stored in the bill presentment and payment module 104 (FIG. 1) may be processed via an online portal server 202 which comprises a web server 204, an application server 206, and one or more databases 208. In an exemplary embodiment of the present invention, the databases 208 may include, but is not limited to, a relational database management system, such as, Oracle, Microsoft SQL Server, etc. In another exemplary embodiment of the present invention, the web server 204 may include Microsoft IIS, IBM HTTP server, Apache Webserver etc. In yet another exemplary embodiment of the present invention, the application server 206 may include IBM Websphere, Microsoft windows (for .NET based application) etc.

In an exemplary embodiment of the present invention, the access request may be received by the web server 204 from channels 212 such as the interne or a mobile device via HTTPS protocol. The access requests are in turn retrieved by the application server 206 from the web server 204. In another exemplary embodiment of the present invention, the application server 206 may execute requests which are received from payer 106 from channels 214 such as an IVR or an ATM channel. In various embodiments of the present invention, responses related to the access requests are then delivered to the channels 212 and 214 after the requests are processed by the online portal server 202.

In an embodiment of the present invention, the application server 206 interacts with a financial institution's customer and financial data processing systems 210 to facilitate the process of bill presentment and payment 104 (FIG. 1). The customer and financial data processing system 210 comprises customer information system 212, core processing system 214, payment gateway 216 and alert system 218. In an embodiment of the present invention, customer information system 212 stores payer 106 (FIG. 1) related customer information including name, address, account numbers etc. In another embodiment of the present invention, customer information system 212 may store similar information for biller 102 (FIG. 1) in case the biller is a customer of the payer's bank. The core processing system 214 facilitates payment transactions between various customer accounts including payer's accounts and biller's accounts. The core processing system 214 also facilitates payment transactions to office account in case biller 102 is not a customer of payer's bank or the biller 102 would like to have a consolidated payment at the end of a specific period instead of being credited directly for every payment made by the payer 106. Payment gateway 216 facilitates processing of payments that may be required to be routed to other banks via payment networks in case funds are to be transferred to the biller 102 (FIG. 1) who is not an account holder with payer's 106 bank. Alert System 218 facilitates generation and delivery of alerts to the payer 106 and the biller 102, including but not limited to, bill presentment and payment related alerts.

In operation, in an embodiment of the present invention, the biller 102 (FIG. 1) may be an account holder of a given financial institution. The biller 102 (FIG. 1) registers with the financial institution for accessing the bill presentment and payment module 104 (FIG. 1) via the online payment portal. In an embodiment of the present invention, at the time of registration, information related to the biller 102 (FIG. 1) including address details and account details may be fetched from the customer information system 212. In another embodiment of the present invention, the information related to the biller may be entered manually. The details fetched may then be stored locally in database 208. After registration, the biller 102 (FIG. 1) is enabled to upload bills or invoices or manually enter the details for presenting to the payer 106 (FIG. 1) via the online payment portal.

The payer 106 (FIG. 1) can access the uploaded bill or invoice via the online payment portal and accept or reject the uploaded bill or invoice after the payer's 106 (FIG. 1) credentials are authenticated. In case the payer 106 (FIG. 1) accepts the bill or invoice, the payable amount may be processed using rules which are derived from terms and conditions agreed upon by the biller 102 (FIG. 1) and the payer 106 (FIG. 1) in accordance with various embodiments of the present invention.

The payment of processed amount may be done by the payer 106 (FIG. 1) instantly or the payment may be scheduled for a later date. The payment is carried out by transferring funds, via the core processing system 214, from payer's 106 (FIG. 1) account to biller's 102 (FIG. 1) account. If biller 102 does not have an account with payer's 106 bank, the core processing system 214 transfers funds from payer's account to an office account. The payment is subsequently made to the biller 102 (FIG. 1) at regular intervals after consolidating all payments received for this biller (FIG. 1) in the office account. If payment is to be sent to biller's 102 account in another bank, payment gateway 216 facilitates to route the payment through corresponding payment networks. For alert notification purposes, the biller's contact information may be passed on to the alert system 218.

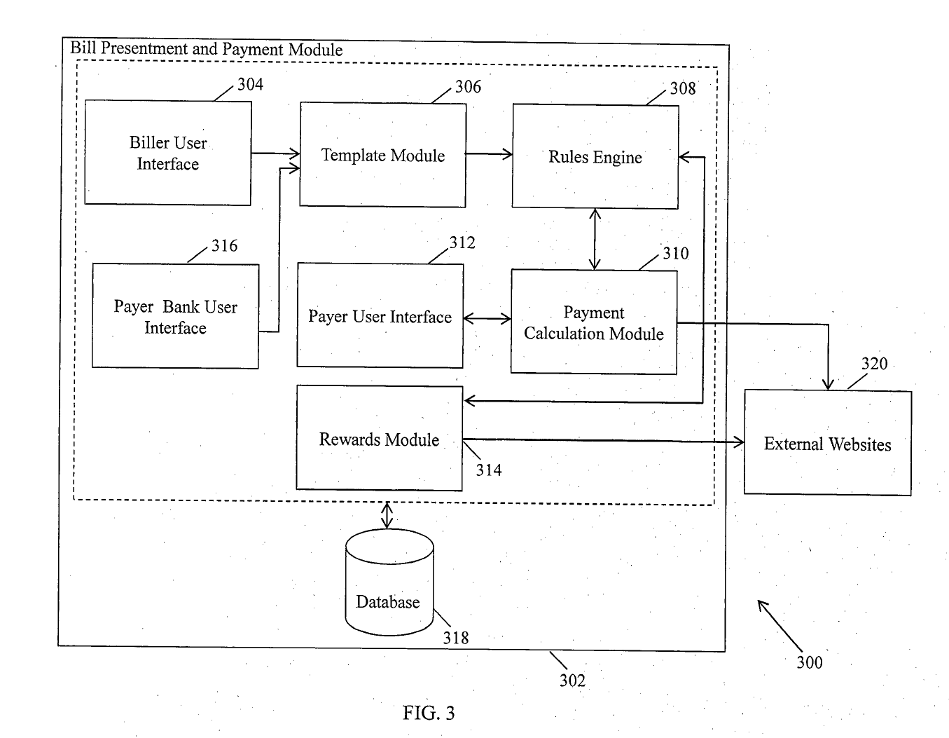

FIG. 3 is a detailed block diagram of the bill presentment and payment module 302, in accordance with an embodiment of the present invention. The bill presentment and payment module 302 comprises a biller user interface 304, a template module 306, a rules engine 308, a payment calculation module 310, a payer user interface 312, a rewards module 314, a payer bank user interface 316 and a database 318.

In various embodiments of the present invention, the biller registers with the financial institution for availing the bill presentment and electronic payment facility via the bill presentment and payment module 302. The biller may include large enterprises as well as small and medium enterprises.

In an embodiment of the present invention, at the time of registration, terms and conditions related to payment for the consumption of products and services by the payer which is agreed upon between the biller and the payer are uploaded by the biller in the bill presentment and payment module 302 using the biller user interface 304. In an exemplary embodiment of the present invention, the biller user interface 304 is a web-based graphical user interface provided in an online payment portal of the payer's financial institution such as an internet banking portal. The terms and conditions may relate to including, but not limited to, bill rejection, calculation of late payment charges, early payment discounts, acceptance of partial payments, acceptance of excessive payments, rewards for online payments etc. The terms and conditions may also relate to restrictions imposed on payment modes, particularly payment of bills or invoices from pre-determined type of bank accounts or credit cards. The terms and conditions may also relate to the channel from which payment can be accepted, for example certain type of payments may not be allowed from ATMs, and certain payments may not be allowed from mobile phones. The terms and conditions may be uploaded by the biller in an Extensible Markup Language (XML) format. The terms and conditions are stored in the bill presentment and payment module 302 in the form of a template.

In an embodiment of the present invention, the template module 306 is a software module configured to generate one or more templates specific to the biller and the payer which are used at the time of processing payment of bills or invoices made by the payer. In an embodiment of the present invention, the template module 306 generates a template using terms and conditions uploaded by the biller and is used at the time of processing payment of the bill or invoice. In an embodiment of the present invention, in case of SME billers' template module 306 may use an application of the Internet banking portal to generate the template.

In an embodiment of the present invention, the template may include a payer identification for identifying the payer of the bill or invoice. In an exemplary embodiment of the present invention, the payer identification may include bank customer identification of the payer which facilitates to identify the relationship between the payer and the biller, as well as address and account details of the payer etc. In another embodiment of the present invention, the template module 306 may include a default template. Default template is used whenever a template is not explicitly specified in a bill or invoice or in a file containing multiple bills or invoices. In an exemplary embodiment of the present invention, default template may be defined by a biller. In another exemplary embodiment of the present invention, if default template is not defined by the biller, the payer's bank may define a default template which may be used at overall bank level. The default template includes predetermined logic used by the payer's bank for processing payment by the payer.

In an embodiment of the present invention, the template module 306 assigns a unique template identification to the template that is specific to the biller and which can be used for one or multiple payers.

In an exemplary embodiment of the present invention, for billers which represent large enterprises, the administrator of the payer's bank may provide a list of payers to the biller, via the payer bank user interface 316, for which bill or invoice is required to be uploaded along with corresponding unique template identification. The bill or invoice is uploaded based on inputs received from the payers. Using the payer user interface 312 the prospective payers may convey to their bank that they would like to electronically receive bills or invoices for a particular biller. Payer's bank may further convey the above mentioned information to biller who extracts this information using biller user interface 304. In another exemplary embodiment of the present invention, the biller and the payer may communicate directly. In various embodiments of the present invention, biller uploads the bill or invoice using the biller user interface 304 which facilitates the biller to input data which is required for uploading the bill or invoice according to a predetermined format for presentment. In an exemplary embodiment of the present invention, along with the unique template identification, the bill or invoice may include details such as a unique bill or invoice identification, payer's account number, a unique customer identification related to the payer, bill or invoiced amount, payment due date etc. In an embodiment of the present invention, the biller may also enter bill or invoice details on a template via the biller user interface 304 instead of a bulk upload of bills or invoices, against a unique template identification number.

In another embodiment of the present invention, the payer may view the uploaded bill or invoice by accessing the bill presentment and payment module 302 for making payment. The payer may initiate payment process using the payer user interface 312 which facilitates the payer to input parameters including, but not limited to, payer identification, date of payment, the unique bill identification etc. Before processing the payment, the unique template identification indicated in the bill or invoice is used to identify the corresponding template which is used for deriving rules by the rules engine 308 for processing payment made by the payer. In an embodiment of the present invention, rules engine 308 is a software module configured to translate terms and conditions indicated in the template to one or more rules before processing payment made by the payer. In an exemplary embodiment of the present invention, the terms and conditions may effect variation in amount to be payed by the payer compared to amount indicated in the bill or invoice. The rules engine 308 may interface with a payment calculation module 310 for calculating a fee automatically when one or more rules that effect variation in billed amount is implemented. In another embodiment of the present invention, the payment calculation module 310 may be an integral part of the rules engine 308 for calculation of fees. In an embodiment of the present invention, the payment calculation module 310 comprises predetermined logic for automatically calculating the fee using values that are provided by the rules engine 308. The values are predetermined by the biller as part of terms and conditions and are indicated in the template. The values may be modified by the biller at a later date as per requirement.

In an embodiment of the present invention, the rules engine 308 may interface with the rewards module 314 to assess rewards which may be due to the payer based on the terms and conditions agreed between the payer and the biller. Payer's bank will calculate the rewards based on the rules derived from the terms and conditions which may be accumulated as reward points. In an exemplary embodiment of the present invention, the reward points may be redeemed at a later date. In another exemplary embodiment of the present invention, the reward points may be a percentage discount on amount indicated in the bill or invoice. In yet another exemplary embodiment, rewards module 314 may invoke a web service on an external website 320 as indicated in the template to determine reward points.

In an exemplary embodiment of the present invention, the rules engine 308 may identify that the payer has made an early payment i.e. payment has been made ‘n’ number of days in advance of the payment due date, by comparing the date of payment with payment due date in the bill or invoice. The rules engine 308 identifies a specific template for the bill or invoice. The template indicates, as one of the terms and conditions between the biller and the payer, that discount may be provided on billed amount if payer has made an early payment. In an exemplary embodiment of the invention, the rules engine 308 then applies ‘discount’ rule on the billed amount before accepting the payment by using a percentage value (referred as P1) indicated in the template. The payment calculation module 310 uses the percentage value P1 to calculate percentage of the billed amount. In another exemplary embodiment, payment calculation module 310 may invoke a web service on an external website 320 as indicated in the template to determine discount value. The discount value may then be calculated using an algorithm which is different than computation of percentage P1.

In another exemplary embodiment of the present invention, the rules engine 308 identifies that the payer has made partial payment and checks it against a minimal payable amount for that particular payer. In operation, the rules engine 308 identifies a specific template for the bill or invoice. The template indicates, as one of the terms and conditions between the biller and the payer, that in case a payer wishes to make partial payment, at least a minimal predetermined amount must be payed by the payer. In an exemplary embodiment of this invention, the rules engine 308 then applies ‘minimum payable amount’ rule on the billed amount before accepting the payment by using a percentage value (referred as P2) indicated in the template. The payment calculation module 310 uses the percentage value P2 to calculate percentage of the billed amount which is then used as the minimum payable amount to compare it against the partial payment. In another exemplary embodiment, payment calculation module 310 may invoke a web service on an external website 320 as indicated in the template to compute minimal acceptable amount. Based on the comparison, if the partial payment is determined to be more than the minimal payable amount, the payment is accepted.

In yet another exemplary embodiment of the present invention, the rules engine 308 identifies that the payer has made payment later than the due date for payment by comparing it against the payment due date in the bill or invoice. The rules engine 308 identifies a specific template for the bill or invoice. The template indicates ‘late fee’ as one of the terms and conditions between the biller and the payer. In an exemplary embodiment, the rules engine 308 then applies ‘late fee’ rule on the billed amount before accepting the payment by using a percentage value (referred as P3) indicated in the template. The payment calculation module 310 uses the percentage value P3 to calculate percentage of the billed amount which is used as the late fee amount and added to the actual bill or invoice. In another exemplary embodiment, payment calculation module 310 may invoke a web service on an external website 320 as indicated in the template to compute late fee amount which is to be added to the actual bill or invoice. The updated amount is then presented to the payer for payment.

In another exemplary embodiment of the present invention, the one or more rules which may require calculation of fees, may include, but are not limited to, rules related to differential pricing to different payers for consumption of same products or services. The differential pricing may be based on information related to payers such as category of payers (e.g. senior citizens, minors, gold customers etc.), location of payer (e.g. different amount to be charged to a resident and an expatriate). In an exemplary embodiment of the present invention, information related to payers may be obtained from customer information system 212 (FIG. 2).

In another embodiment of the present invention, the one or more rules may include biller related rules including, but not limited to, withdrawing the bill or invoice by the biller and thereby sending the status of the bill or invoice as ‘withdrawn’, changing payment due date in the bill or invoice based on mutual negotiation between the biller and the payer, waiving off unpaid amount of the bill or invoice, and rules related to bill or invoice expiry. For example, the rule related to bill or invoice expiry may specify that biller may not allow payment of an invoice ‘n’ days after payment due date and shall add the billed amount as arrear in the next bill or invoice. Further, if payment received is higher than invoice amount, the biller related rule may include accepting the payment if excess payment is allowed. Furthermore, if payment received is higher than the discounted amount, the biller related rule may include accepting the payment if excess payment is allowed.

In another embodiment of the present invention, the one or more rules may include rules related to payer including, but not limited to, rejecting a bill or invoice, paying a bill or invoice in an order other than the sequence in which bill or invoice is uploaded by the biller and selecting by the payer to pay any outstanding bill or invoice (i.e. invoices which are not rejected, withdrawn, expired and not paid fully). In an embodiment of the present invention, the system 300 may send alert messages to the payer using the alert system 214 (FIG. 2) in case of outstanding bills or invoices.

In an embodiment of the present invention, the template includes certain terms and conditions between biller and payer's bank related to commission which is due to payer's bank for facilitating collection of bills or invoices. These terms and conditions can be viewed and accepted by payer's bank using payer bank user interface 316. In an exemplary embodiment of present invention, this can be computed by payment calculation module 310 as percentage P4 based on amount indicated in the bill or invoice which may be lower when large number of bills or invoices are expected. In another exemplary embodiment, commission calculation can be implemented as a web service on an external website 320 which is invoked by the payment calculation module 310.

In yet another embodiment of the present invention, the biller may not indicate a unique template identification while uploading the bill. In such a case, the rules engine 308 implements one or more rules using the default template for a particular biller. If default template for a particular biller does not exist then a default template determined by the payer's bank for all the billers is used. In an exemplary embodiment of the present invention, the default template may indicate various parameters as described above.

In various embodiments of the present invention, database 318 stores biller and payer registration information, templates from which rules representing terms and conditions between billers and payers as well as billers and payer's bank are derived, uploaded bills or invoices and actual payment transactions.

In various embodiments of the present invention, the system 300 facilitates sending an alert message to the biller via the alert system 214 (FIG. 2) in the payer's bank that the template providing terms and conditions have been accepted by payer and by the payer's bank and hence corresponding bills or invoices can be uploaded by the biller. After the payment is processed, the system 300 facilitates generating and transferring a payment report to the biller. The system 300 also facilitates maintaining a list of external agencies such as tax authorities for whom the biller collects additional charges levied within the bill or invoice besides amount due to the biller and provides a facility for the biller to use the biller user interface 304 to generate reports to facilitate filing tax returns etc.

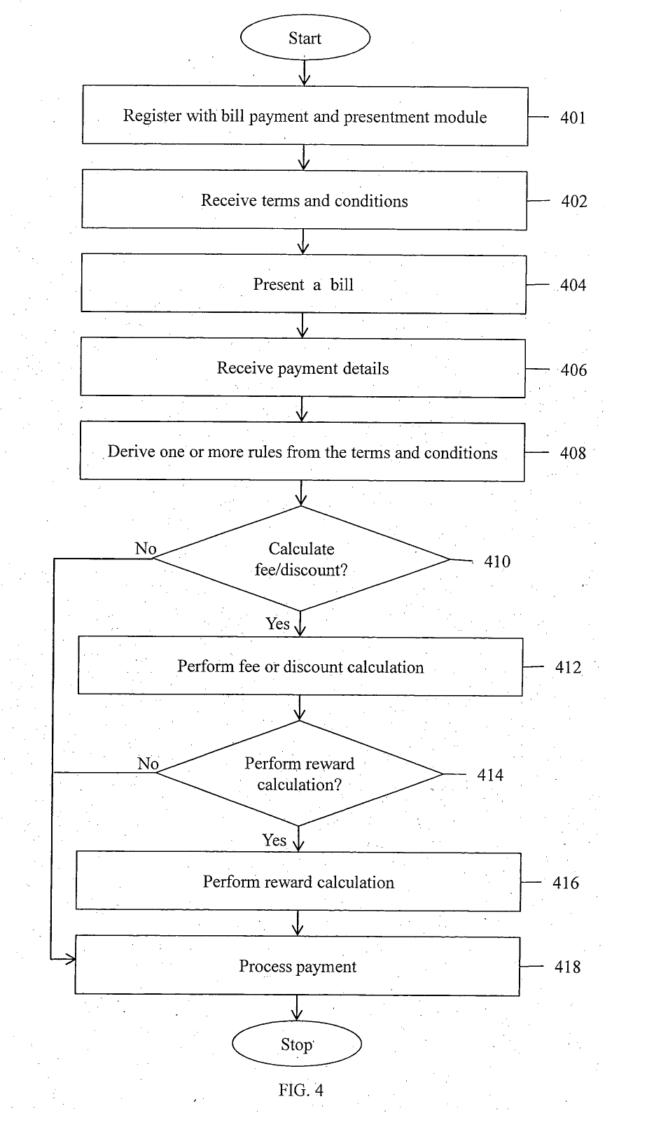

FIG. 4 illustrates a flowchart of a method for rule-based presentment and payment of bills or invoices, in accordance with an embodiment of the present invention.

At step 401, the biller and payer may register with the bill presentment and payment module. In an embodiment of the present invention, the biller receives registration identification along with authentication details. In another embodiment of the present invention, the payer may register with the bill presentment and payment system and receive registration identification along with authentication details. The biller and the payer may access the bill presentment and payment system using the respective registration identifications.

At step 402, a set of terms and conditions which provide various conditions for use or payment of products or services offered by the biller to the payer, and have been agreed upon between the biller and the payer are received. The set of terms and conditions may be stored in the bill presentment and payment module in the form of a template which is specific to the biller and which can apply to one or more payers.

In an exemplary embodiment of the present invention, the template includes percentage values for calculation of late payment fees, percentage values for early payment discounts, percentage values for partial payments, allowing for excessive payments, allowing payment of bills or invoices in an order other than bill date, differential pricing. In another exemplary embodiment of the present invention, the template includes information related to usage of algorithms running as web services on external websites for calculation of late payment fees, early payment discounts, minimum payment amounts and reward points.

In yet another exemplary embodiment of the present invention, template includes certain terms and conditions between biller and payer's bank including, but not limited to, commission earned by payer's bank for facilitating the bill collection. Commission can be calculated as percentage of bill or invoice amount, a fixed amount based on tiered slab or any other appropriate ways of calculation. Biller may agree to default algorithm as specified by payer's bank on their web site. Alternately, both biller and payer's bank can agree on algorithm hosted on an external website that is used for calculation of commission. Template is forwarded for approval to the payer(s) only if biller agrees to terms and conditions proposed by payer's bank without changes or if the changes proposed by ‘biller to these terms and conditions are agreed to by the payer's bank.

At step 404, a bill or invoice is uploaded for presentment. In an embodiment of the present invention, a biller uploads a bill for consumption of products and services by payer via a user interface. In an embodiment of the present invention, the biller may upload a single bill. In another embodiment of the present invention, the biller may upload a file including necessary details on each bill. The bill may include details such as a unique bill identification, payer's account number, a unique customer identification related to the payer, billed amount, payment due date etc.

In another embodiment of the present invention, the bill or invoice may also include reference to a specific template such as template identification. The template includes one or more details which may be used for processing the bill or invoice payment when the payer makes payment of the bill or invoice. In an exemplary embodiment of the present invention, separate template may be generated for separate payers. In another exemplary embodiment of the present invention, a single template may include one or more payer categories for identifying the differential terms and conditions that have been agreed between the biller and the payers for payment of the bill or invoice. For example, the template may include a particular set of conditions for retired payers and a different set of conditions for working payers. In an exemplary embodiment of the present invention, the template may be generated based on data provided by the biller using an application of the online payment portal. In another exemplary embodiment of the present invention, the template may be generated based on data provided by an administrator of the payer's bank using an application of the online payment portal.

In yet another embodiment of the present invention, if the bill or invoice does not include reference to a specific template, a default template may be used for processing the bill or invoice when the payer makes a payment of the bill or invoice. The default template may include one or more details which are used by the payer's bank for processing the bill or invoice. In another embodiment of the present invention, if the biller is not an account holder in the payer's bank, then the biller may be registered with the bank on-the-fly. The biller may then be authorized to carry out bill presentment as well as processing payer's payment of bill using the default template provided by payer's bank. In an embodiment of the present invention, in case the biller identifies an error based on negotiation with payer, the biller may withdraw previous bill and resubmit bill changing details such as payment due date or payment amount.

At step 406, payment details are received. In an embodiment of the present invention, a payer accesses the uploaded bill or invoice for viewing bill or invoice details via a user interface which is accessed via an online banking portal. The payer accepts the bill or invoice and initiates the payment process by providing payment details such as, payer identification, bill or invoice identification, date of payment, amount of payment etc. In another embodiment of the present invention, the payer may reject the bill or invoice in which case the biller may reload the bill or invoice.

At step 408, one or more rules are derived from the terms and conditions before processing payment. In an embodiment of the present invention, the one or more rules are derived to implement terms and conditions that are indicated in the template. The one or more derived rules when applied on the bill or invoice facilitates to derive processing logic from the bill or invoice for processing payment made by the payer. The one or more rules, based on terms and conditions indicated in the template, may effect variation in amount to be payed by the payer compared to amount indicated in the bill or invoice. In another embodiment of the present invention, one or more rules may include rules stated by the biller such as not accepting an electronic payment for bills or invoices received after a particular date, allowing partial payments by payer, allowing excess payments by payer etc.

At step 410, a check is performed to determine if fee or discount calculation is required. In an embodiment of the present invention, one or more rules, based on terms and conditions indicated in the template, determines if the fee or discount calculation needs to be performed. At step 412, fee or discount calculation is carried out. In an exemplary embodiment of the present invention, the one or more rules may include ‘late payment’ rules if the payment is made ‘n’ days after the payment due date. A late payment fee can be obtained by calculating a percentage of the billed amount using a percentage value agreed between biller and payer. The percentage value may be provided in the template. Alternately, late payment fee can also be calculated by applying a predetermined algorithm or set of predetermined conditions for calculation of fee hosted as a web service on an external website. In another exemplary embodiment of the present invention, the one or more rules include ‘discount’ rules for payers who pay in say first ‘n’ days of bill or invoice issue date. A discount is obtained by calculating a percentage of the billed amount using a percentage value which may be provided in the template as agreed between biller and payer or by applying an predetermined algorithm for calculation of fee hosted as a web service on an external website.

At step 414, a check is performed to determine if reward calculation is to be performed based on the terms and conditions agreed between the biller and payer. If it is determined that reward calculation is to be performed, then, at step 416, reward calculation is carried out by the payer's bank and the results are informed to the payer. The reward calculation may result in either a percentage discount on the current bill if reward points are redeemed immediately or may result in accumulation of reward points. In case the reward points redemption results into a discounted amount on the bill or invoice, the corresponding bill or invoice amount is calculated by deducting the reward amount from the bill or invoice amount. Otherwise the reward points may be calculated and archived in a reward module for redeeming the same at a later date.

At step 418, payment is processed. In an embodiment of the present invention, payment is processed applying the calculated fee or discount at step 412 and rewards calculation at step 416. If it is determined, at step 410, that fee or discount calculation is not required and if it is determined, at step 414, that reward calculation is not required, then, at step 418, payment is processed using one or more rules derived from terms and conditions.

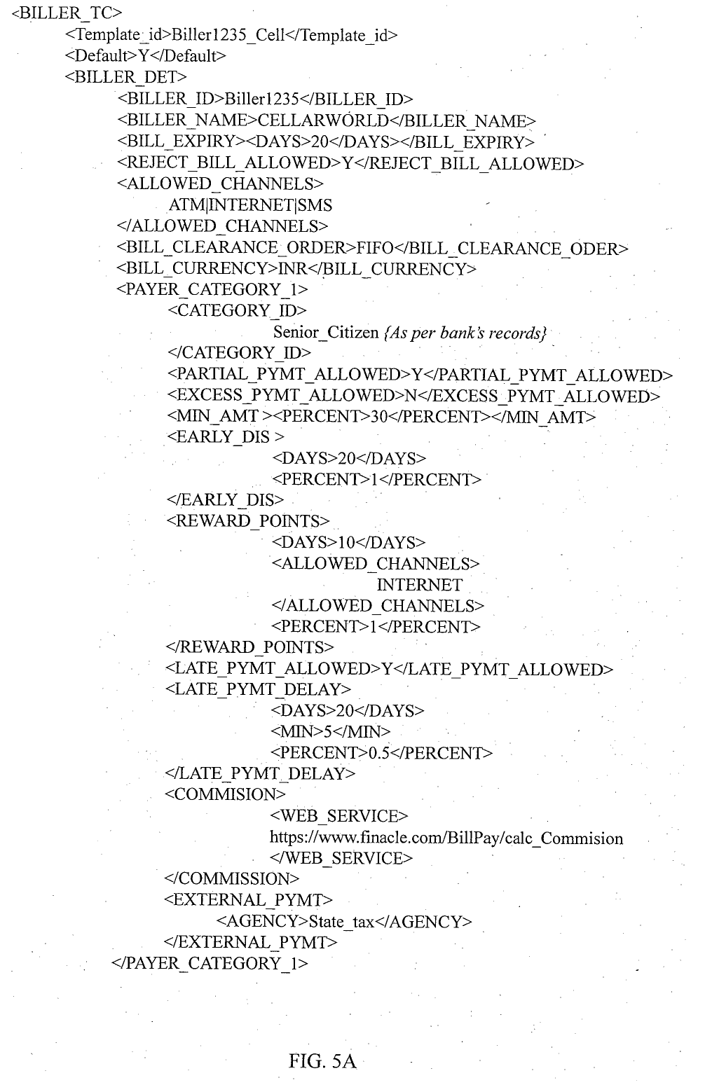

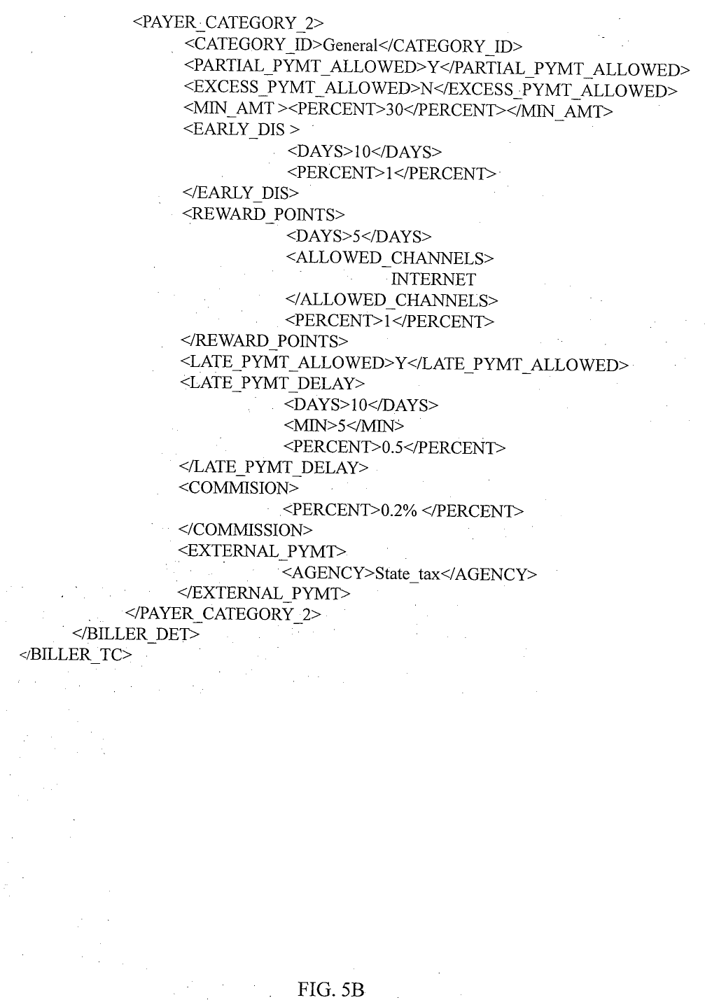

FIGS. 5A and 5B is an exemplary XML code illustrating the method of the present invention in accordance with various embodiments of the present invention.

The present invention may be implemented in numerous ways including as an apparatus, a method, or a computer program product such as a computer readable storage medium or a computer network wherein programming instructions are communicated from a remote location.

Various embodiments of the present invention, may be implemented via one or more computer systems. The computer system includes at least one processing unit and memory. The processing unit executes program instructions and may be a real or a virtual processor. The computer system is not intended to suggest any limitation as to scope of use or functionality of described embodiments. Typical examples of a computer system include a general-purpose computer, a programmed microprocessor, a micro-controller, a peripheral integrated circuit element, and other devices or arrangements of devices that are capable of implementing the steps that constitute the method of the present invention. In an embodiment of the present invention, the memory may store software for implementing various embodiments of the present invention.

The present invention may suitably be embodied as a computer program product for use with a computer system. The method described herein is typically implemented as a computer program product, comprising a set of program instructions which is executed by a computer system or similar device. The set of program instructions may be a series of computer readable codes stored on a tangible medium, such as a computer readable storage medium, for example, diskette, CD-ROM, ROM, or hard disk, or transmittable to a computer system, via a modem or other interface device, over either a tangible medium, including but not limited to optical or analogue communications lines. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

We claim:

1. A computer-implemented method for facilitating presentment and payment of bills or invoices related to consumption of products and services between a biller and a payer via an online payment portal over a communication network, the method comprising the steps of:
generating a template, by program instructions executed by a computer system, defining terms and conditions related to payment of a bill or invoice, wherein the terms and conditions are accepted by the payer and the payer's financial institution and received from the biller;
deriving one or more rules, by program instructions executed by a computer system, from data related to the terms and conditions defined in the template;
applying the derived one or more rules, by program instructions executed by a computer system, on the bill or invoice associated with the template to derive processing logic; and
processing payment of the bill or invoice made by the payer, by program instructions executed by a computer system, using the derived processing logic.

2. The computer-implemented method of claim 1, wherein the terms and conditions between the biller and the payer comprises at least one of: percentage values for calculation of late payment fees, percentage values for early payment discounts, percentage values for partial payments, allowing for excessive payments, allowing payment of bills or invoices in an order other than bill or invoice date, differential pricing based on payer categorization made by payer's financial institution, and usage of a predetermined algorithm running as web services on external websites for calculation of late payment fees, early payment discounts, minimum payment amounts and reward points.

3. The computer-implemented method of claim 1, wherein the terms and conditions between the biller and payer's financial institution comprises at least one of: percentage values for calculation of commission related to the payer's financial institution for facilitating collection of bill or invoice and usage of a predetermined algorithm running as web services on external websites for calculation of commission amount.

4. A computer-implemented method for facilitating presentment and payment of bills or invoices related to consumption of products and services between a biller and a payer via an online payment portal over a communication network, the method comprising the steps of:
generating a template, by program instructions executed by a computer system, defining terms and conditions received from the biller and accepted by the payer and the payer's financial institution, wherein the template is allotted a unique template identification that corresponds to the biller and one or more payers;
presenting, by program instructions executed by a computer system, a bill or invoice based on data received from the biller, via a user interface, wherein the bill or invoice indicates at least the unique template identification;
identifying, by program instructions executed by a computer system, the template based on at least the unique template identification indicated in the bill or invoice after the bill or invoice is accessed by the payer, via a user interface, for payment;
deriving one or more rules, by program instructions executed by a computer system, from data related to the terms and conditions defined in the identified template;
applying the derived one or more rules, by program instructions executed by a computer system, on the bill or invoice associated with the identified template to derive processing logic; and
processing payment of the bill or invoice, by program instructions executed by a computer system, by applying the derived processing logic.

5. The computer-implemented method of claim 4, wherein deriving one or more rules from the terms and conditions defined in the template comprises deriving rules that result in variation in the payment amount in relation to the amount indicated in the bill or invoice.

6. The computer-implemented method of claim 5, processing payment of the bill or invoice by applying the derived processing logic further comprises:
calculating a fee or a discount, by program instructions executed by a computer system, different from the amount indicated in the bill or invoice based on the one or more derived rules.

7. The computer-implemented method of claim 6, processing payment of the bill or invoice by applying the derived processing logic further comprises:
comparing payment details, by program instructions executed by a computer system, received from the payer, via a user interface, with payment details indicated in the bill or invoice;
validating the payment details, by program instructions executed by a computer system, against the one or more derived rules, wherein the one or more derived rules comprises at least one of: late payment, early payment, minimum amount, partial payment, differential pricing, excess payment, and paying bill or invoices or invoices in an order other than first in first out; and
calculating a fee or discount, by program instructions executed by a computer system, based on the validation.

8. The computer-implemented method of claim 7, wherein the payment details comprises at least one of: date of payment and amount of payment

9. The computer-implemented method of claim 4, wherein the bill or invoice further indicates a bill identification, bill due date and payment amount.

10. The computer-implemented method of claim 5, processing payment of the bill or invoice by applying the derived processing logic further comprises:
assessing reward points, by program instructions executed by a computer system, to be provided to the payer based on the derived rules.

11. The computer-implemented method of claim 4, processing payment of the bill or invoice by applying the derived processing logic further comprises at least one of: restricting payments from pre-determined payment modes which includes restricting payments from pre-determined account types, and restricting payments from pre-determined channels from which payment is not permitted.

12. A system for facilitating presentment and payment of bills or invoices related to consumption of products and services between at least one biller and at least one payer via an online payment portal over a communication network, the system comprising:
a template module on a computer system and configured to generate at least one template defining terms and conditions, wherein the at least one template is allotted a unique template identification that corresponds to the at least one biller and at least one payer;
a rules engine on the computer system and in communication with the template module configured to:
identify the at least one template corresponding to the at least one biller and the at least one payer using the unique template identification after the bills or invoices are accessed by the at least one payer;
derive one or more rules based on data related to the terms and conditions defined in the identified template; and
process payment of the bills or invoices by applying the one or more derived rules.

13. The system of claim 13 further comprises a biller user interface on the computer system and configured to receive data related to terms and conditions between payer and corresponding biller and further configured to receive data related to bills or invoices for presentment of the bills or invoices.

14. The system of claim 13 further comprises a payer user interface on the computer system and configured to receive data related to payment of bills or invoices.

15. The system of claim 13 further comprising a payment calculation module on the computer system and in communication with the rules engine, wherein the payment calculation module is configured to calculate a fee or discount different from the amount indicated in the bill based on one or more percentage values determined by the derived rules.

16. The system of claim 13, further comprising a payment calculation module on the computer system and in communication with the rules engine, wherein the payment calculation module is configured to invoke a web service on an external website for calculation of fee or discount different from the amount indicated in the bill or invoice using a predetermined algorithm and for calculation of commission which is due to payer's financial institution for facilitation of bill or invoice collection service.

17. The system of claim 13 further comprising a rewards module on the computer system and in communication with the rules engine, wherein the rewards module is configured to at least one of: assess reward points for allotting to the payer based on the rules derived from the terms and conditions and calculate a discounted amount on the bill or invoice by deducting a reward amount from the bill or invoiced amount.
